(19) United States
(12) Patent Application Publication
(10) Pub. No.: US 2012/0144006 A1
(43) Pub. Date: Jun. 7, 2012

(54) COMPUTER SYSTEM, CONTROL METHOD OF COMPUTER SYSTEM, AND STORAGE MEDIUM ON WHICH PROGRAM IS STORED

(75) Inventors: Takahiko Wakamatsu, Yokohama (JP); Yoji Onishi, Fujisawa (JP)

(73) Assignee: Hitachi, Ltd.

(21) Appl. No.: 13/390,020

(22) PCT Filed: Aug. 5, 2010
(86) PCT No.: PCT/JP2010/063276

§ 371 Date: Feb. 10, 2012

(30) Foreign Application Priority Data
Mar. 12, 2010 (JP) 2010-055544

(51) Int. Cl. G06F 15/177

(52) U.S. Cl. 709/220

(57) ABSTRACT

A control method of a computer system where a management server having configuration management information for managing I/O switches for connecting a plurality of computers with a plurality of I/O devices controls the allocation of the I/O devices for the computers where the management server acquires identifiers of a first computer and an I/O device that has been allocated to the first computer and stores them in the configuration management information, receives a switch from the first computer to a second computer, stops the first computer, allocates the I/O device that had been allocated to the first computer to the second computer, activates the second computer, and rewrites the identifier of a specific I/O device among the I/O devices that have been switched to the second computer to a pre-set virtual identifier.

### BACKGROUND OF THE INVENTION

This invention relates to management of a computer coupled to a PCI-Express switch.

Up to now, a PCI device is mounted inside a computer, but can now be handled outside the computer as a PCI-Express switch has become commercially practical. Therefore, for example, as described in JP 2005-301488 A, a PCI bus is easily changed over to thereby allow an I/O configuration to be flexibly changed.

In order to improve reliability of a computer system, there is a recovery method of providing an active-system server and a standby-system server to thereby change over the active-system server to the standby-system server at a time of a fault. There is an increasing demand to share an I/O device by coupling the active-system server and the standby-system server to the PCI-Express switch to thereby assemble a flexible I/O configuration while maintaining the reliability of the computer system.

### SUMMARY OF THE INVENTION

Server management software includes one that determines a physical position of a server to be managed from a media access control address (MAC address) associated with a network interface card (NIC) of the server to be managed. However, as described in the above-mentioned conventional example, in a case where a changeover has occurred from an active-system server coupled to a PCI-Express switch to a standby-system server coupled thereto, MACs thereof associated with the NIC are the same because the active-system server and the standby-system server are coupled to the NIC of the same PCI device through the PCI-Express switch. This raises a problem that management software cannot detect a change in the physical position of the server to be managed and that an administrator cannot continue operation and management of the server.

Therefore, this invention has been made in view of the above-mentioned problem, and an object thereof is to grasp a physical position of each server from a management server even in a case where an active-system server has been changed over to a standby-system server in a state in which an I/O device is shared by coupling the active-system server and the standby-system server to the PCI-Express switch.

According to the present invention, there is provided a computer system, comprising: a plurality of computers each comprising a processor, a memory, and an I/O interface; one or a plurality of I/O switches to which the plurality of computers are coupled via the I/O interface; a plurality of I/O devices that are coupled to the one or plurality of I/O switches; and a management server comprising configuration management information for managing the plurality of I/O devices coupled to the plurality of computers via the one or plurality of I/O switches, for controlling allocation of the plurality of I/O devices to the plurality of computers, wherein: the management server comprises a configuration management module that receives a changeover from a first computer to a second computer among the plurality of computers and allocates the I/O device allocated to the first computer to the second computer; the configuration management module comprises: an identifier detection module that acquires an identifier of the first computer among the plurality of computers and an identifier of the I/O device allocated to the first computer and stores the identifier of the first computer and the identifier of the I/O device in the configuration management information; an I/O switch changeover module that transmits an instruction to change over the I/O device allocated to the first computer to the second computer to the one or plurality of I/O switches; and a device identifier rewriting module that rewrites an identifier of a specific I/O device within the configuration management information to a virtual identifier that has been previously set; the I/O switch changeover module transmits, after stopping the first computer, the instruction to change over the I/O device allocated to the first computer to the second computer to the one or plurality of I/O switches; and the device identifier rewriting module rewrites, after activating the second computer, the identifier of the specific I/O device among the I/O devices that have been changed over to the second computer to the virtual identifier.

Therefore, according to this invention, an administrator can determine that the physical position of the computer has changed from the identifier unique to the I/O device to the virtual identifier even in a case where a changeover has occurred between an active system and a standby system in the computers coupled to the I/O switch (PCI-Express switch).

### BRIEF DESCRIPTION OF THE DRAWINGS

FIG. 1 is a block diagram illustrating an entirety of a computer system according to the embodiment of this invention.

FIG. 2 is a block diagram illustrating a configuration of the management server.

FIG. 3 is a block diagram illustrating a configuration of a server according to the embodiment of this invention.

FIG. 4 illustrates one of operation outlines according to the embodiment of this invention.

FIG. 5 illustrates one of the operation outlines according to the embodiment of this invention, and illustrates an example of the failover.

FIG. 6 illustrates the server management table according to the embodiment of this invention.

FIG. 7 illustrates the server I/O configuration information table according to the embodiment of this invention.

FIG. 8 is an explanatory diagram illustrating a virtual identifier table according to the embodiment of this invention.

FIG. 9 is a flowchart illustrating an example of a processing performed by the device identifier detection module of the management server according to the embodiment of this invention.

FIG. 10 is a flowchart illustrating an example of a processing performed by the server fault recovery module according to the embodiment of this invention.

FIG. 11 is a flowchart illustrating an example of a processing performed by the I/O switch changeover module according to the embodiment of this invention.

FIG. 12 is a flowchart illustrating an example of a processing performed by the device identifier acquisition/selection module according to the embodiment of this invention.

FIG. 13 is a flowchart illustrating an example of a processing performed by the device identifier rewriting module according to the embodiment of this invention.

### DETAILED DESCRIPTION OF THE PREFERRED EMBODIMENT

Hereinafter, an embodiment of this invention is described with reference to the accompanying drawings.

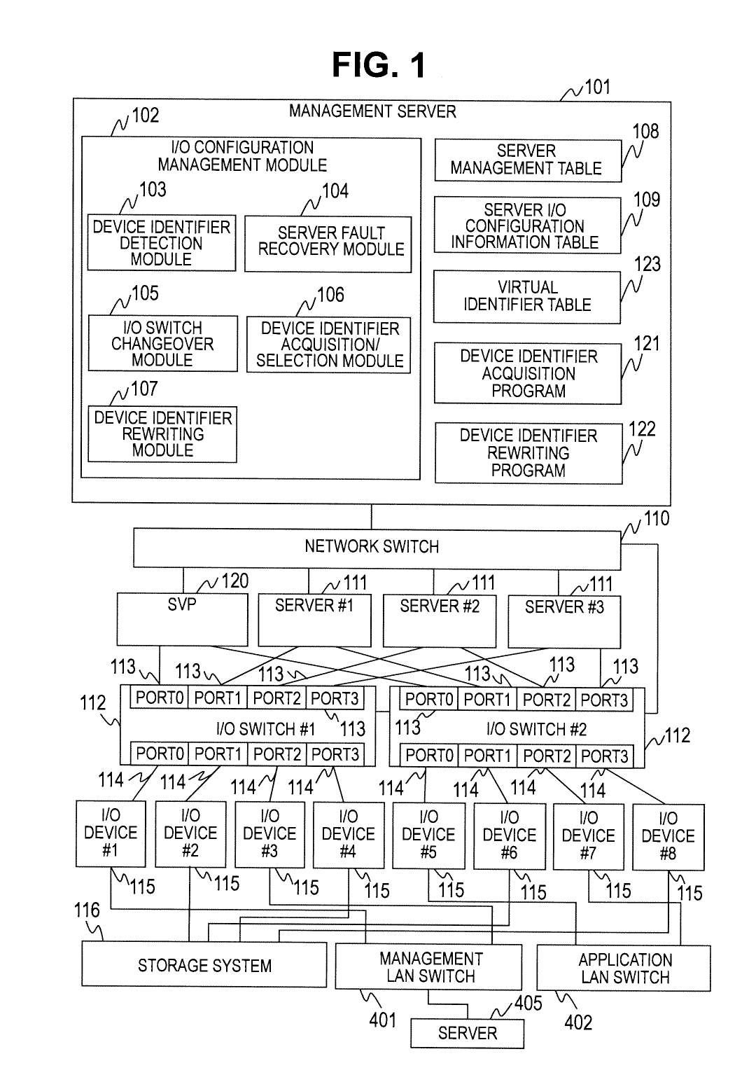

FIG. 1 is a block diagram illustrating an entirety of a computer system according to the embodiment of this invention. In the computer system of FIG. 1, an active-system server 111 and a standby-system (standby-system) server 111 are configured by a plurality of servers 111, an I/O switch 112 that can change over an I/O device 115 is shared by an active system and a standby-system, and the active system and the standby-system are changed over according to an instruction from a management server 101.

The management server 101 functions as a main part of control for the computer system according to this embodiment. The management server 101 executes an I/O configuration management module 102, various tables (108, 109, and 123), a device identifier acquisition program 121, and a device identifier rewriting program 122. The I/O configuration management module 102 includes a device identifier detection module 103, a server fault recovery module 104, an I/O switch changeover module 105, a device identifier acquisition/selection module 106, and a device identifier rewriting module 107.

The management server 101 is coupled to the plurality of servers 111, a plurality of I/O switches 112, and a service processor (hereinafter, referred to as “SVP”) 120 at a firmware layer via a network switch 110. The I/O switch 112 includes a plurality of upstream ports 113 coupled to the servers 111 and the SVP 120 and a plurality of downstream ports 114 coupled to a plurality of I/O devices 115, and couples the servers 111 and the SVP 120 to the I/O device 115. Some of the plurality of I/O devices 115 are configured as host bus adapters (HBAs) coupled to a storage system 116, and allow the servers 111 to access the storage system 116.

Further, some of the plurality of I/O devices 115 are configured as network interface cards (NICs) coupled to a management LAN switch 401 and an application LAN switch 402, and allow the servers 111 to access the management LAN switch 401 and the application LAN switch 402.

It should be noted that with regard to the plurality of servers 111, the respective servers 111 are identified by suffixes #1 to #3, the plurality of I/O switches 112 are similarly identified by suffixes #1 and #2, the upstream ports 113 and the downstream ports 114 are respectively identified by suffixes 0 to 3, and the I/O devices 115 are identified by suffixes #1 to #8.

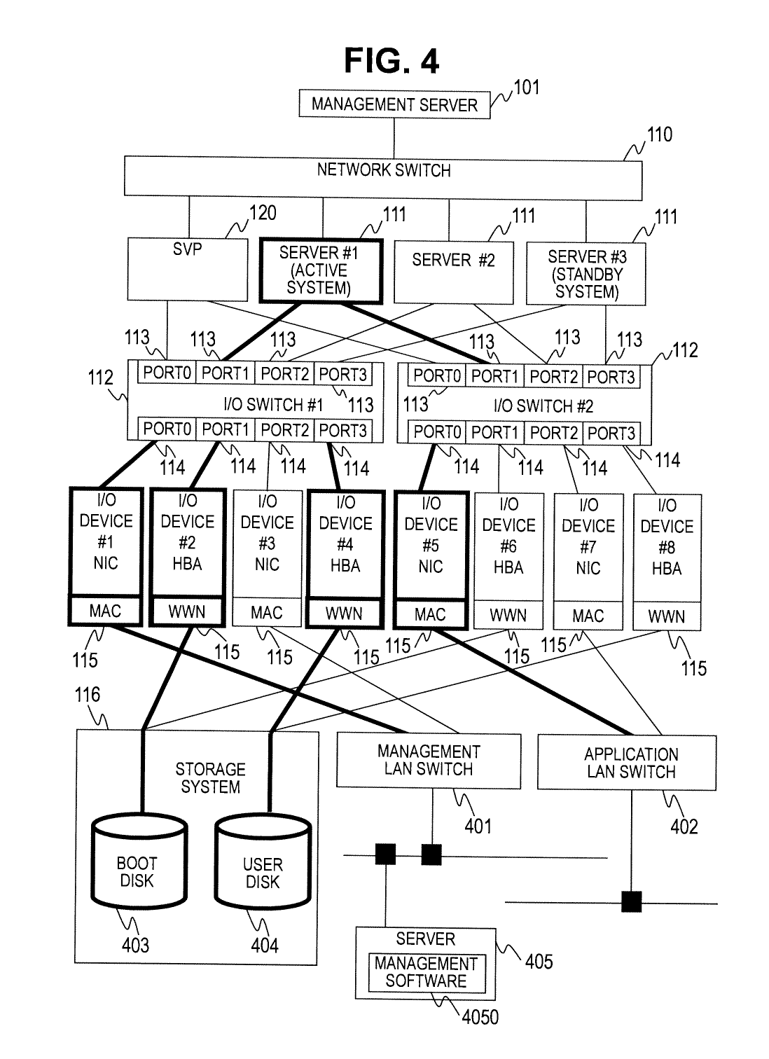

The management LAN switch 401 forms a management network that serves to allow a server 405 on which management software 4050 (see FIG. 4) is running or the like to manage servers #1 to #3. It should be noted that as described in the above-mentioned conventional example, the management software 4050 of the server 405 executes the servers #1 to #3 at MAC addresses of the NICs coupled to the servers #1 to #3.

The application LAN switch 402 couples the servers #1 to #3 to an external computer or the like, and forms an application network that provides services of the servers #1 to #3 to the external computer and the like.

The management server 101 has a function of detecting a fault in the servers 111, the I/O switches 112, and the I/O devices 115 and performing a recovery from the fault. The device identifier detection module 103 has a function of detecting a device identifier of the I/O device 115 coupled to the server 111. Examples of the device identifier of the I/O device 115 include a MAC of the NIC coupled to a specific network and a world wide name (WWN) of the HBA coupled to a specific storage system.

The server fault recovery module 104 has a function of detecting a fault in the servers 111, the I/O switches 112, and the I/O devices 115 and performing a recovery from the detected fault. The I/O switch changeover module 105 has a function of acquiring information within a server management table 108 and a server I/O configuration information table 109 and performing a changeover of the I/O switch 112.

The device identifier acquisition/selection module 106 has a function of acquiring information within the server management table 108 and the server I/O configuration information table 109 and selecting a specific device identifier based on the acquired information. The device identifier rewriting module 107 has a function of rewriting the device identifier selected by the device identifier acquisition/selection module 106 to an arbitrary device identifier.

The server management table 108 stores configurations of the server 111 and information on the I/O switch 112 coupled to the server 111. The server I/O configuration information table 109 stores I/O configuration definition information, states, and the like of one or a plurality of I/O switches 112 coupled to the servers 111 and the I/O devices 115. The device identifier acquisition program 121 stores a program having a function of acquiring an identifier specific to the I/O device 115. The device identifier rewriting program 122 stores a program having a function of rewriting the identifier specific to the I/O device 115.

This embodiment is an embodiment indicating that, in a case where a fault has occurred in any one of the plurality of servers 111, the management server 101 temporarily stops the server 111 that has caused the fault, changes over the I/O switch 112, rewrites information on the plurality of I/O devices 115 coupled to the server 111 that has caused the fault, and activates the standby-system server 111 to take over the I/O device 115 of the server 111 that has caused the fault.

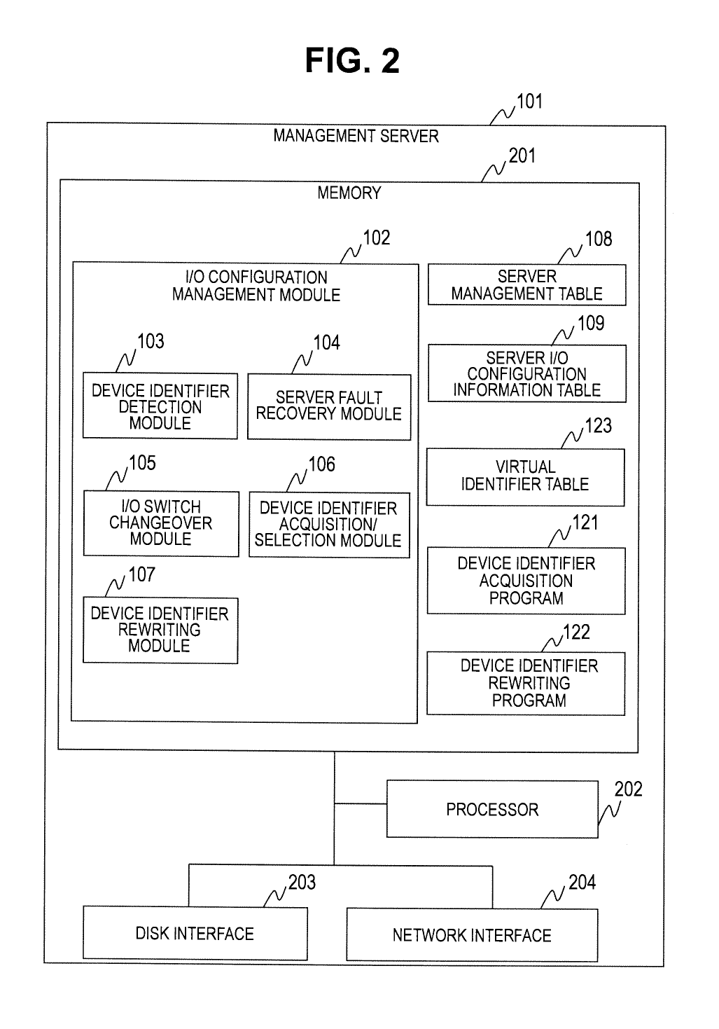

FIG. 2 is a block diagram illustrating a configuration of the management server 101. The management server 101 includes a memory 201, a processor 202, a disk interface 203, and a network interface 204. Stored in the memory 201 are the server management table 108, the server I/O configuration information table 109, the device identifier acquisition program 121, and the device identifier rewriting program 122.

The I/O configuration management module 102 includes the device identifier detection module 103, the server fault recovery module 104, the I/O switch changeover module 105, the device identifier acquisition/selection module 106, and the device identifier rewriting module 107. The I/O configuration management module 102, the device identifier acquisition program 121, and the device identifier rewriting program 122 within a memory are read and executed by the processor 202. The disk interface 203 is coupled to a disk (not shown) functioning as a storage medium that stores the above-mentioned respective programs for activating the management server 101. The network interface 204 is coupled to a network formed by the network switch 110 and the like to transfer fault information on the respective devices and other such information and also transfer an instruction from the management server 101. It should be noted that those functions may be implemented by hardware.

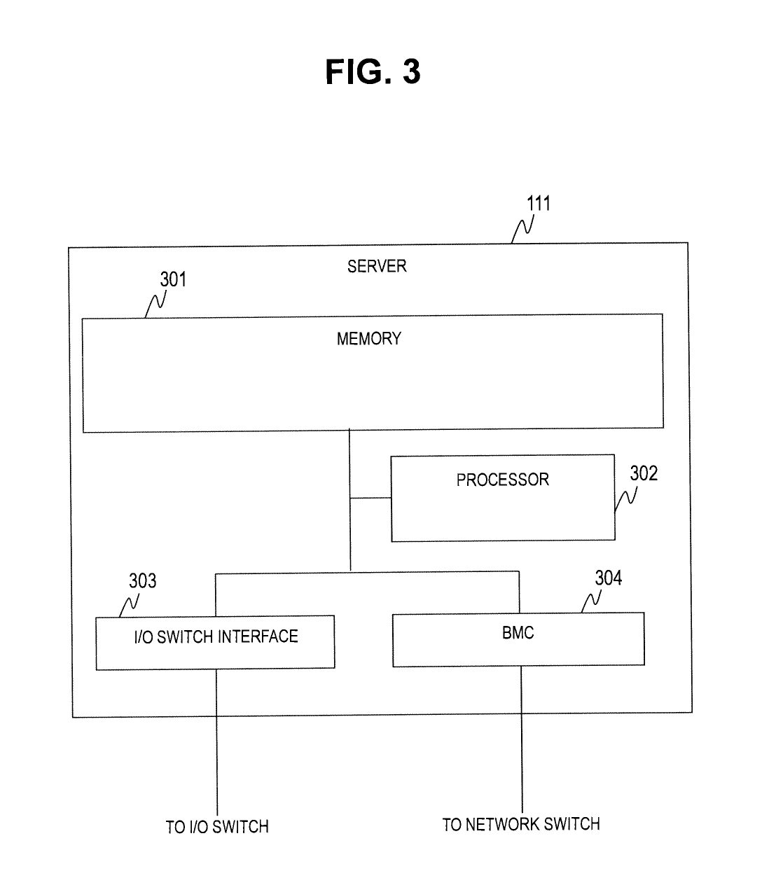

FIG. 3 is a block diagram illustrating a configuration of the server 111. The plurality of servers 111 (#1 to #3) illustrated in FIG. 1 have the same configuration. The server 111 includes a memory 301, a processor 302, an I/O switch interface 303, and a base board management controller (BMC) 304. The memory 301 stores a program processed on the server 111, and the program is executed by the processor 302. The I/O switch interface 303 is coupled to the I/O switch 112. The BMC 304 has a function of notifying the SVP 120 of a fault via the network switch 110 in a case where the fault has occurred in hardware inside the server 111. The BMC 304 can operate independently of a portion in which the fault has occurred, and can therefore transfer a fault notification even if the fault has occurred in the memory 301 or the processor 302.

It should be noted that the I/O switch 112, the I/O switch interface 303, and the I/O device 115 according to this embodiment conforms to the standards of PCI-Express.

Further, the SVP 120 is a computer including a processor, a memory, and a network interface, and manages an operating state of the server 111. The SVP 120 monitors the BMC 304 of each of the servers 111, and when a notification of the fault is received from the BMC 304, notifies the management server 101 of the server 111 that has caused the fault. When an instruction for activation, resetting, or the like of the server 111 is received from the management server 101, the SVP 120 instructs the BMC 304 of the corresponding server 111 to perform the activation, resetting, or the like thereof.

FIG. 4 illustrates one of operation outlines according to this invention. The server 111 is coupled to the plurality of I/O devices 115 via the plurality of I/O switches 112. Further, the I/O devices 115 have different coupling destinations in accordance with the device.

In the example of FIG. 4, the server 111 (#1) forms the active system, and the server 111 (#3) forms the standby-system. It should be noted that in the following description, the respective devices are identified by the above-mentioned suffixes indicated in FIG. 1. The figure illustrates an example in which I/O devices #1, #3, #5, and #7 are configured by the NICs and I/O devices #2, #4, #6, and #8 are configured by the HBAs.

An active-system server #1 is coupled to an upstream port 1 of an I/O switch #1 and an upstream port 1 of an I/O switch #2 via the I/O switch interface 303. On the I/O switch #1, the upstream port 1 is coupled to downstream ports 0, 1, and 3. Then, the downstream port 0 is coupled to the I/O device #1 configured by the NIC, and the downstream ports 1 and 3 are coupled to the I/O devices #2 and #4 configured by the HBAs. On the I/O switch #2, the upstream port 1 is coupled to a downstream port 0. Then, the downstream port 0 of the I/O switch #2 is coupled to the I/O device #5 configured by the NIC.

The NIC of the I/O device #1 is coupled to the management LAN switch 401, and the NIC of the I/O device #5 is coupled to the application LAN switch 402. The HBA of the I/O device #2 is coupled to a boot disk 403 of the storage system 116, and the HBA of the I/O device #4 is coupled to a user disk 404 of the storage system 116. It should be noted that the boot disk 403 and the user disk 404 of the storage system 116 are provided as logical units.

The active-system server #1 set as described above accesses the boot disk 403 and the user disk 404 via the I/O switches #1 and #2, and is coupled to the server 405 via the management LAN switch 401 and to a computer providing a service via the application LAN switch 402.

In the above-mentioned configuration, the active-system server #1 acquires only a designated device identifier coupled to the management LAN switch 401 among the I/O devices #1, #2, #4, and #5 that are coupled thereto via the I/O switches #1 and #2, and transmits the designated device identifier to the management server 101. The designated device identifier can be arbitrarily set by a user (or administrator). For example, in a case where the I/O devices #1 and #5 of the server #1 are the NICs, the server #1 transmits only a unique identifier (MAC) of the NIC (I/O device #1) coupled to the management LAN switch 401 among the plurality of I/O devices #1 and #5 coupled to the I/O switch interface 303 to the management server 101 as the designated device identifier.

In other words, in order to provide the services of the servers #1 to #3 by being coupled to another computer, the application LAN switch 402 forms a network in which an identifier (MAC address) of the NIC (I/O device #5) that has been taken over from the active-system server #1 by a standby-system server 3 must not be changed even after a failover is performed from the active-system server #1 to the standby-system server 3 at a time of an occurrence of a fault.

In contrast thereto, in order to manage the servers #1 to #3 by the management software 4050 by being coupled to the server 405, the management LAN switch 401 forms a network in which an identifier (MAC address) of the NIC (I/O device #3) that has been taken over from the active-system server #1 by the standby-system server 3 is changed after the failover is performed from the active-system server #1 to the standby-system server 3 at the time of the occurrence of the fault.

In the state of FIG. 4, a standby-system server #3 is coupled to each of an upstream port 3 of the I/O switch #1 and an upstream port 3 of the I/O switch #2, but each of the upstream ports 3 is not coupled to a downstream port.

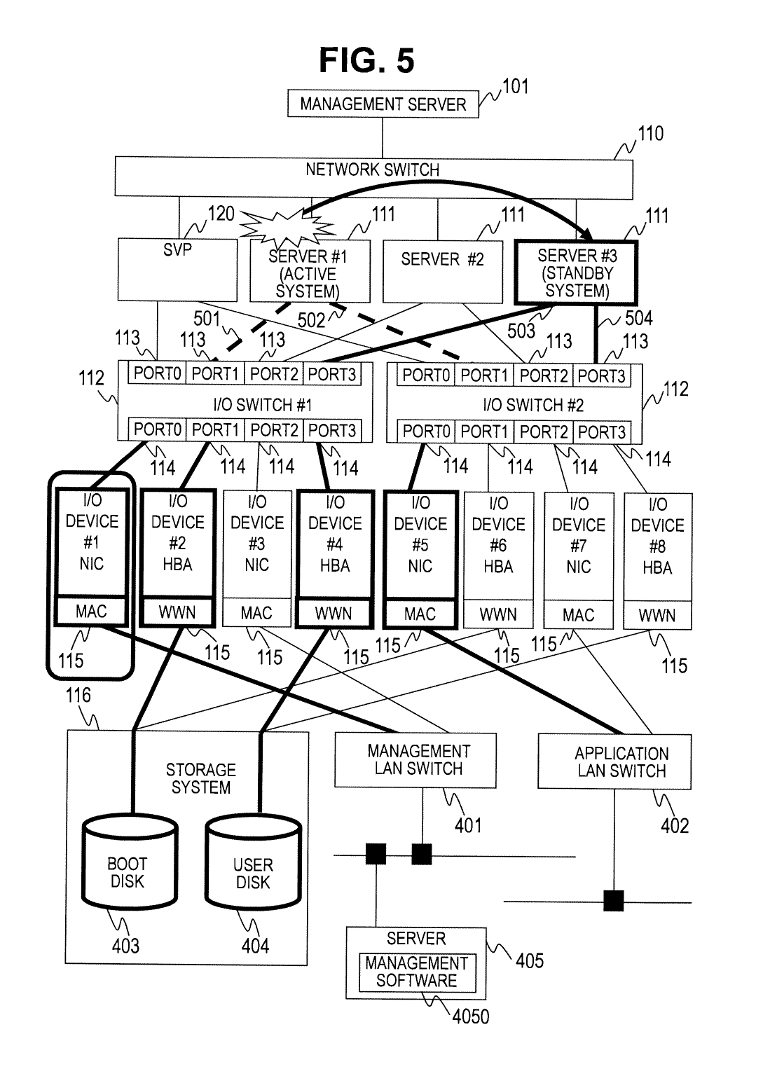

FIG. 5 illustrates one of the operation outlines according to this invention, and illustrates an example of the failover. FIG. 5 illustrates an example in which a fault has occurred in the active-system server #1 under an environment illustrated in FIG. 4 and a processing thereof is taken over to the standby-system server #3.

In the case where a fault has occurred in the active-system server #1, the management server 101 temporarily stops the active-system server #1. Then, the management server 101 instructs the I/O switches 112 to change over from the active-system server #1 to the standby-system server #3, and the I/O switches 112 change over the coupling between the upstream ports 113 and the downstream ports 114 to thereby couple all the I/O devices 115 coupled to the active-system server #1 to the standby-system server #3.

In other words, a path between the server 111 and the I/O switch 112 is changed from a path 501 to a path 503 and from a path 502 to a path 504 as illustrated in FIG. 5. At this time, it is important to keep the path between the I/O switch 112 and the I/O device 115 from being changed.

Subsequently, the management server 101 activates the standby-system server #3, and rewrites only a specific device identifier (MAC) of the NIC (the I/O device #1) coupled to the management LAN switch 401 to a virtual identifier that has been set in advance.

At this time, the management server 101 has a feature of instructing the rewriting of only the device identifier (MAC) of the I/O device #1 (the NIC) coupled to the management LAN switch 401 and not instructing the rewriting of the device identifier of the I/O device #5 (the NIC) coupled to the application LAN switch 402. Further, in a case where the I/O device 115 is the HBA, the rewriting of the device identifier can also be applied to the device identifier (WWN) and the like.

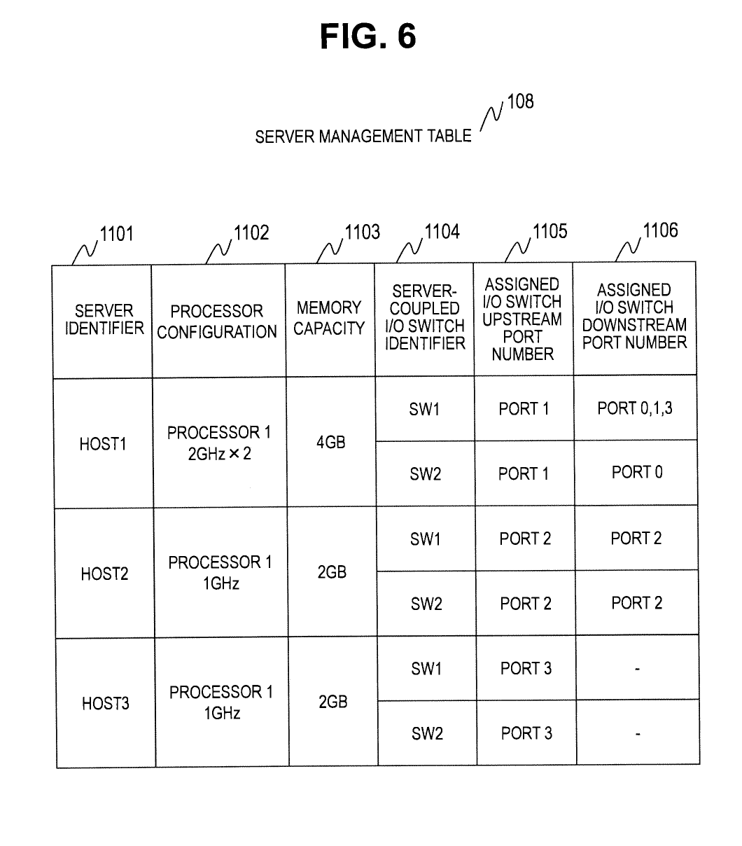

FIG. 6 illustrates the server management table 108. A column 1101 represents a server identifier. A column 1102 stores a processor configuration of the server 111, and a column 1103 stores a memory capacity. A column 1104 stores an identifier of the I/O switch 112 coupled to the server 111.

A column 1105 stores a port number of the upstream port 113 of the I/O switch 112 coupled to the server 111. A column 1106 stores a port number of the downstream port 114 coupled to the I/O device 115 allocated to the server 111.

The server management table 108 retains a correlation among the identifiers of the I/O switches 112 of the I/O devices 115 allocated to the servers #1 to #3 (HOST1 to HOST3 in the figure), the port numbers of the downstream ports 114, and the port numbers of the upstream ports 113.

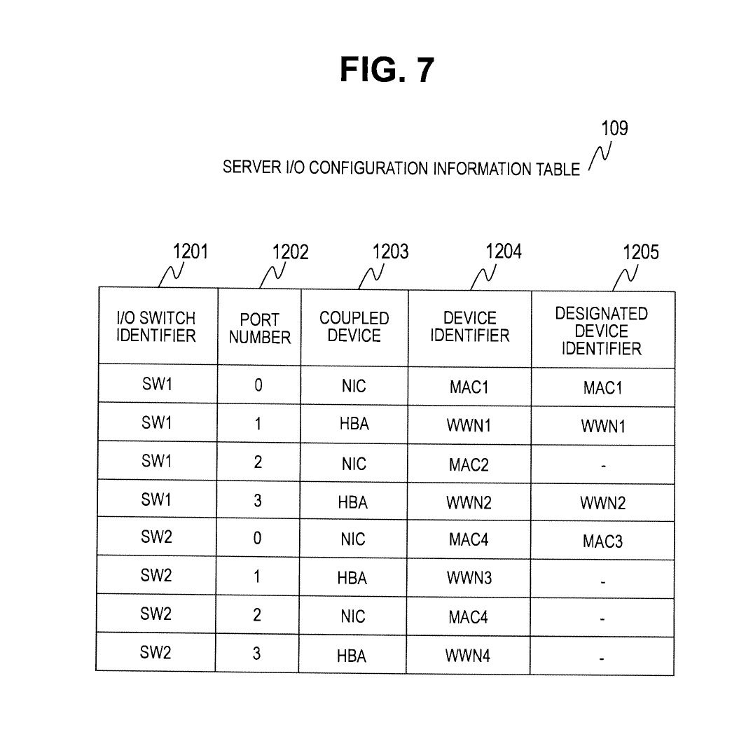

FIG. 7 illustrates the server I/O configuration information table 109. A column 1202 stores the identifier of the I/O switch 112. A column 1202 stores the port number of the downstream port 114 of the I/O switch 112. A column 1203 stores a type of the I/O device 115 coupled to the downstream port 114. A column 1204 stores an identifier unique to the I/O device 115 as the device identifier. A column 1205 stores the designated device identifier notified of from the server 111. Further, with regard to the designated device identifier, a plurality of designated device identifiers may be stored with respect to a coupled device 1203.

The device identifier is an identifier unique to the I/O device 115 to be managed, and is formed of, for example, the MAC or the WWN. The designated device identifier indicates the device identifier of the I/O device 115 coupled to the management network among the I/O devices 115 coupled to the server 111 to be managed. It should be noted that a flag indicating that the device is coupled to the management network may be used as the designated device identifier in place of the device identifier.

By managing the server I/O configuration information table 109, it is possible to manage a plurality of I/O configurations with respect to one server 111.

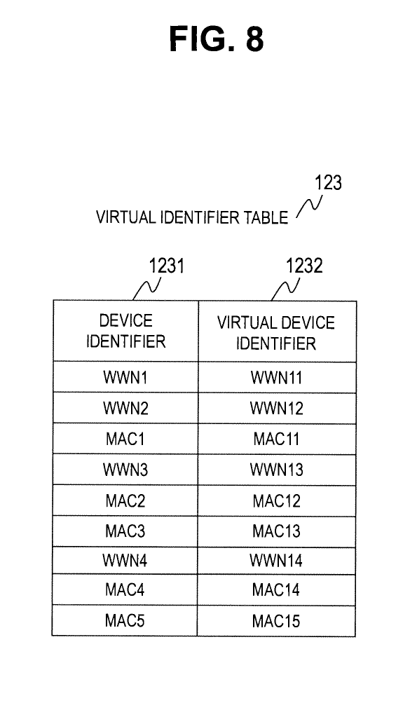

FIG. 8 is an explanatory diagram illustrating a virtual identifier table 123. The virtual identifier table 123 is structured of a column 1231 storing the unique identifier of the I/O device 115 coupled to the I/O switch 112 and a column 1232 storing a virtual device identifier set by the management server 101.

The virtual device identifier is an identifier that is given to the I/O device 115 in place of the device identifier unique to the I/O device 115 in order to notify the server 405 that the server 111 has been changed over due to the failover or the like.

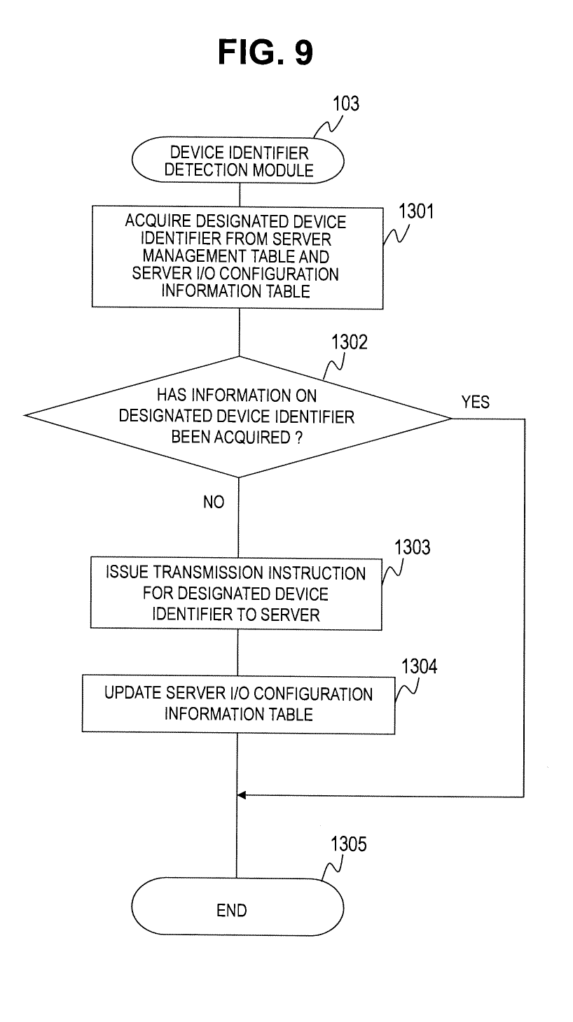

FIG. 9 is a flowchart illustrating an example of a processing performed by the device identifier detection module 103 of the management server 101. This processing is a processing that is always performed in a case where the management server 101 manages the server 111, and examples thereof include the activation of the server 111, the stopping thereof, and the changing of the I/O device 115.

In Step 1301, the device identifier detection module 103 of the management server 101 acquires the designated device identifier of the server 111 from the server management table 108 and the server I/O configuration information table 109. In Step 1302, the device identifier detection module 103 determines whether or not information on the designated device identifier of the server 111 has been acquired. If the designated device identifier has been acquired, the procedure advances to Step 1303, and if there is no designated device identifier, the processing is finished.

In Step 1303, the device identifier detection module 103 issues a transmission instruction for the designated device identifier to the server 111. For example, in a case where the I/O device (NIC) 115 is coupled to the server 111, the transmission instruction for the MAC address is transmitted. The transmission instruction for a plurality of designated device identifiers can be given with regard to the plurality of I/O devices 115 coupled to the plurality of servers 111.

In Step 1304, the device identifier detection module 103 stores the designated device identifier, which has been received as a response to the transmission instruction for the designated device identifier, in the server I/O configuration information table 109.

Through the above-mentioned processing, the device identifier detection module 103 acquires the device identifier of the I/O device 115 coupled to the management network from each of the servers 111 as the designated device identifier, and stores the device identifier as a designated device identifier 1205 of the server I/O configuration information table 109. It should be noted that in response to the transmission instruction for the designated device identifier issued from the device identifier detection module 103, the server 111 does not notify of the device identifier of the I/O device 115 that is not coupled to the management network. For example, in the configuration of FIG. 4, the server 111 returns the MAC of the I/O device #1 coupled to the management LAN switch 401 to the management server 101, but does not notify the management server 101 of the device identifiers of the I/O devices #2, #4, and #5. Further, the server 111 can determine the I/O device 115 that can communicate with a predetermined device (for example, server 405) within the management network as the I/O device 115 coupled to the management network.

The above-mentioned processing can be repeatedly performed for all the servers 111 to be managed by the management server 101.

It should be noted that in a case where the management server 101 is coupled to the management network, the management server 101 may be configured to acquire the device identifier of the I/O device 115 from the management network.

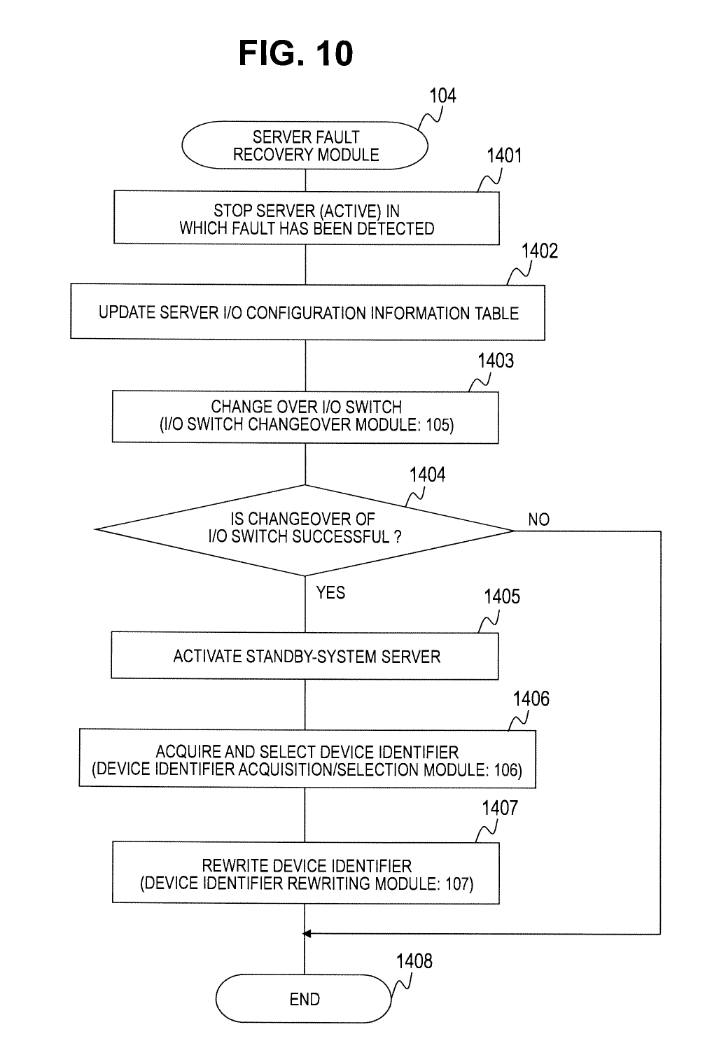

FIG. 10 is a flowchart illustrating an example of a processing performed by the server fault recovery module 104. The server fault recovery module 104 executes the processing of FIG. 10 when receiving a notification of the fault of the server 111 from the SVP 120. It should be noted that detection of the fault is not limited to the notification from the SVP 120, but may be such detection that the server fault recovery module 104 detects heartbeats of the respective servers 111, and a publicly-known or well-known method can be employed.

In Step 1401, the server fault recovery module 104 stops the activation of the active-system server 111 notified of from the SVP 120 when detecting the fault of the active-system server 111 (server #1 of FIG. 4). In Step 1402, the server fault recovery module 104 acquires I/O switch information from the SVP 120 and the I/O switch 112, and updates the server management table 108 and the server I/O configuration information table 109. The I/O switch information indicates a coupling relationship between the upstream ports 113 and the downstream ports 114 of all the I/O switches 112. In Step 1402, the server fault recovery module 104 identifies the downstream port 114 that had been coupled to the active-system server 111 that has stopped due to the occurrence of the fault, and acquires the I/O device 115 that had been used by the active-system server 111 that has stopped.

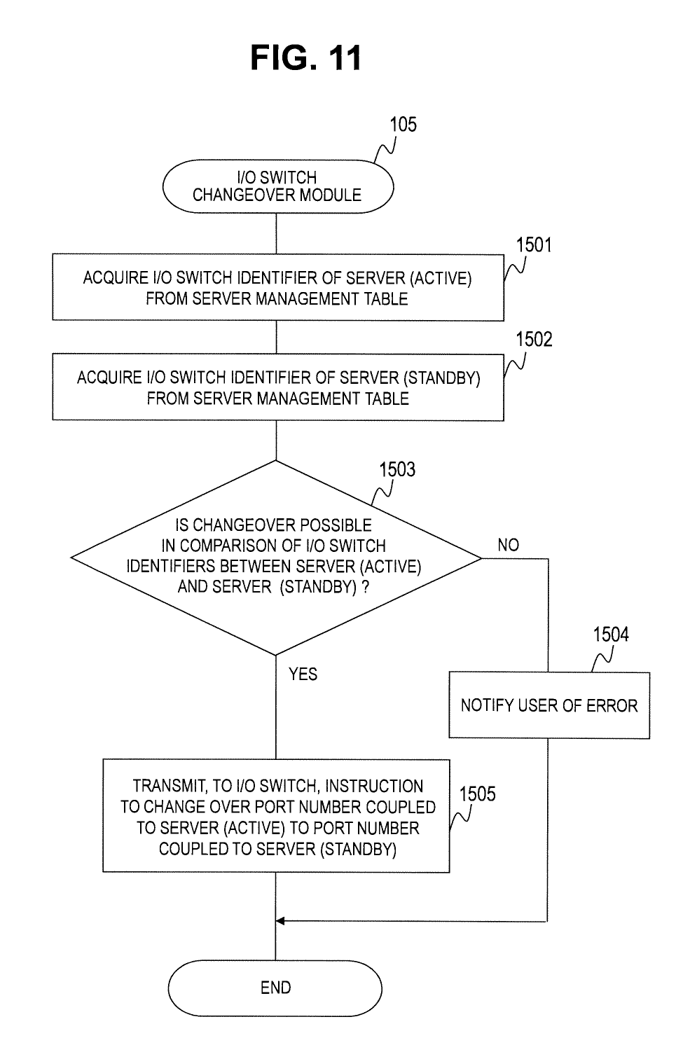

In Step 1403, in order to change over the active-system server 111 that has stopped to the standby-system server 111 (server #3 of FIG. 4), the I/O switch changeover module 105 executes a changeover of the I/O switch 112. In other words, from the coupling relationship between the upstream ports 113 and the downstream ports 114 of the respective I/O switches 112 acquired by the server fault recovery module 104, the I/O switch changeover module 105 instruct a changeover of the I/O device 115 from the active-system server 111 that has stopped due to the fault to the standby-system server 111. This instruction is such an instruction that the I/O switch changeover module 105 instructs the respective I/O switches 112 to change over the downstream port 114 for the subject I/O device 115 to the upstream port 113 coupled to the standby-system server 111. It should be noted that the processing executed by the I/O switch changeover module 105 is described later in detail with reference to FIG. 11.

In Step 1404, the I/O switch changeover module 105 determines whether or not the changeover of the I/O switch 112 instructed in Step 1403 results in a success or a failure. This determination can be directed to a determination as to whether or not the changeover of the coupling between the upstream port 113 and the downstream port 114 has been successful based on a response made by the I/O switch 112 to the instruction issued by the I/O switch changeover module 105 or the like.

In Step 1405, after the I/O device 115 of the active-system server 111 that has caused the fault is coupled to the standby-system server 111 by the I/O switch changeover module 105, the server fault recovery module 104 activates the standby-system server 111. At this time, in a case where the I/O device 115 coupled to the standby-system server 111 is the NIC (I/O device #1 of FIG. 4) coupled to the management network, the subject NIC may be isolated from the management network by previously setting a virtual LAN (VLAN) for the NIC. The NIC is thus isolated from the management network by the VLAN in order to prevent the management software 4050 from erroneously recognizing that the server 111 that has caused the fault has been activated again when the standby-system server 111 is activated as it is with the I/O device 115 being the NIC coupled to the management network because the management software 4050 of the server 405 coupled to the management network manages the server 111 by using the MAC address of the NIC.

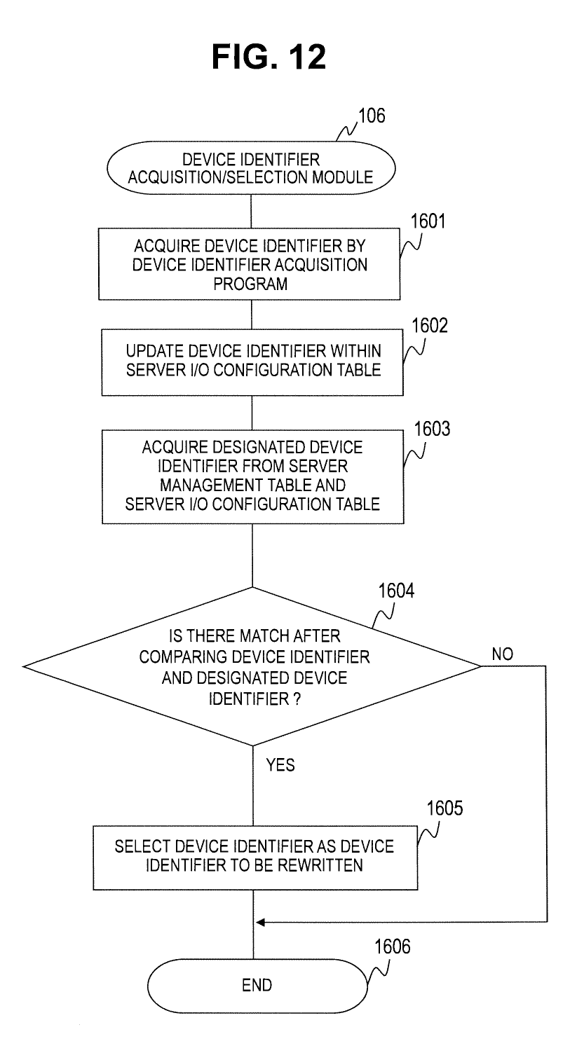

In Step 1046, the device identifier acquisition/selection module 106 executes acquisition and selection of the designated device identifier of the I/O device 115 coupled to the standby-system server 111. As described later with reference to FIG. 12, the device identifier acquisition/selection module 106 selects the I/O device 115 to which the virtual device identifier is to be given from among the I/O devices 115 coupled to the management network. In the example of FIG. 4, the I/O device #1 coupled to the management network is selected as a subject to be given the virtual device identifier.

In Step 1047, the device identifier rewriting module 107 executes rewriting of the designated device identifier of the I/O device 115 coupled to the standby-system server 111.

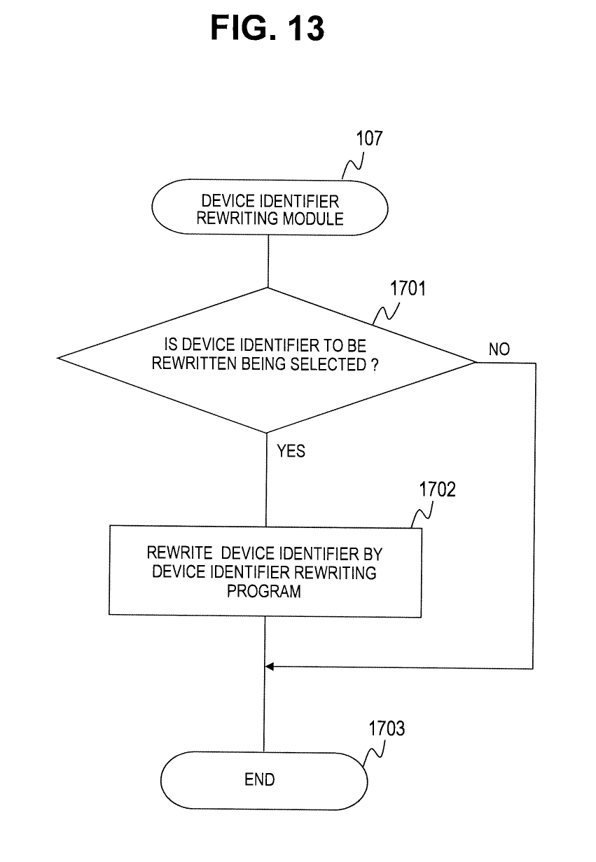

As described later with reference to FIG. 13, the device identifier rewriting module 107 instructs the standby-system server 111 to rewrite the device identifier (MAC1 of FIG. 8) of the I/O device 115 (NIC of I/O device #1) selected in Step 1406 described above with the virtual device identifier (MAC11 of FIG. 8) within the virtual identifier table 123.

Through the above-mentioned processing, with regard to the NIC (I/O device #1) coupled to the management network among the I/O devices 115, the standby-system server 111 that has taken over the I/O device 115 of the active-system server 111 that has caused the fault receives the virtual device identifier (MAC11) from the management server 101 and rewrites the device identifier (MAC1) of the NIC to the virtual device identifier (MAC11).

This allows the management software 4050 of the server 405 coupled to the management network to recognize a new virtual device identifier as the device identifier and to recognize that the standby-system server 111 has taken over the server 111 that has stopped.

Accordingly, the management software 4050 of the server 405 within the management network can grasp a physical position of each server 111 even in a case where the active-system server 111 has been changed over to the standby-system server 111 in a state in which the I/O device 115 is shared by respectively coupling the active-system server 111 and the standby-system server 111 to the I/O switch 112 of PCI-Express.

On the other hand, the device identifier of the NIC coupled to the application network among the I/O devices 115 is the same as before the occurrence of the fault, and hence another computer and the like can access the standby-system server 111 in the same manner as before the occurrence of the fault.

It should be noted that the I/O device 115 coupled to the management network, if isolated by the VLAN, may be coupled to the management network after having the device identifier rewritten to the virtual device identifier and then having settings of the VLAN changed.

FIG. 11 is a flowchart illustrating an example of a processing performed by the I/O switch changeover module 105. This processing indicates details of the processing performed in Step 1403 of FIG. 10 described above.

In Step 1501, the I/O switch changeover module 105 acquires an I/O identifier of the I/O switch 112 coupled to the server 111 that has caused the fault from the server management table 108 and the server I/O configuration information table 109.

In Step 1502, the I/O switch changeover module 105 acquires an I/O identifier of the I/O switch 112 coupled to the standby-system server 111 from the server management table 108 and the server I/O configuration information table 109. In Step 1503, it is determined whether or not the I/O switch 112 can be changed over by performing comparison as to whether or not all the I/O switch identifiers of the I/O switches 112 coupled to the active-system server 111 are included in the I/O switch identifier of the I/O switch 112 coupled to the standby-system server 111. This comparison becomes a determination condition for a switch changeover and is therefore extremely important. In Step 1504 for a case where the I/O switch 112 cannot be changed over, the user (or administrator of the management server 101) is notified of an error.

On the other hand, in Step 1505 for a case where the I/O switch 112 can be changed over, an instruction to rewrite a port number of the I/O switch 112 coupled to the active-system server 111 to a port number of the I/O switch 112 coupled to the standby-system server 111 is transmitted to all the I/O switches 112.

FIG. 12 is a flowchart illustrating an example of a processing performed by the device identifier acquisition/selection module 106. This processing indicates details of the processing performed in Step 1406 of FIG. 10 described above.

In Step 1601, the device identifier acquisition/selection module 106 acquires all the device identifiers of the I/O devices 115 coupled to the servers 111 according to the device identifier acquisition program 121.

In Step 1602, the device identifier acquisition/selection module 106 stores the device identifiers acquired in Step 1601 described above in the server I/O configuration information table 109. In Step 1603, the designated device identifier of the I/O switch 112 coupled to the active-system server 111 that has caused the fault is acquired from the server management table 108 and the server I/O configuration information table 109.

In Step 1604, the device identifier acquisition/selection module 106 searches the virtual identifier table 123 by using the designated device identifier acquired in Step 1602 as a search key, and deter mines whether or not there is a matched device identifier. This search is used to determine whether or not there is a device identifier to be rewritten and therefore has an extremely important meaning. In Step 1605, a virtual device identifier 1232 corresponding to the device identifier matched in Step 1604 is selected as a device identifier to be rewritten.

FIG. 13 is a flowchart illustrating an example of a processing performed by the device identifier rewriting module 107. This processing indicates details of the processing performed in Step 1407 of FIG. 10 described above.

In Step 1701, the device identifier rewriting module 107 determines whether or not the device identifier to be rewritten is being selected by the device identifier acquisition/selection module 106. If the device identifier to be rewritten is being selected by the device identifier acquisition/selection module 106, in Step 1702, the device identifier acquisition/selection module 106 rewrites the device identifier to be rewritten to the virtual device identifier. At this time, it is important that only the device identifier to be rewritten is rewritten by the device identifier acquisition/selection module 106 without rewriting all the other device identifiers. In other words, by rewriting only the device identifier of the I/O device 115 coupled to the management network to the virtual device identifier, the management software 4050 of the server 405 is caused to recognize the activated standby-system server 111. On the other hand, with regard to the other I/O devices 115, by using the device identifiers that have been used by the active-system server 111 as they are, the standby-system server 111 can provide the service and can access the storage system 116 under the same environment as before the changeover.

It should be noted that the example of changing over to the standby-system server 111 at the occurrence of the fault is described above, but also in a case where the management server 101 instructs a changeover to the standby-system server 111 for the purpose of maintenance of the active-system server 111, the device identifier of the I/O device 115 accessed by the management software 4050 may be rewritten to the virtual device identifier that is previously set by the management server 101 as described above. In this case, the server fault recovery module 104 functions as a server changeover module, and executes a changeover from the active-system server 111 to the standby-system server 111 according to an instruction from a console (not shown) or the like of the management server 101.

Further, the processing for rewriting the device identifier of the I/O device 115 to the virtual device identifier is not only performed by the management server 101 instructing the standby-system server 111 as described above, but may also be performed by the management server 101 notifying the SVP 120 of the device identifier and the virtual device identifier and by the SVP 120 rewriting the subject device identifier of the I/O device 115 to the virtual device identifier via the BMC 304.

Further, the example in which the management server 101 is configured by a different computer from that of the server 405 executing the management software 4050 that manages the physical position of the server 111 by using the MAC address is described above, but the management software 4050 may be executed on the management server 101. In this case, a plurality of network interfaces may be provided to the management server 101 and may be respectively coupled to the network switch 110 and the management LAN switch 401.

Further, the example of separately providing: the server management table 108 that retains the relationship among the server 111, the I/O switch 112, and the ports; the server I/O configuration information table 109 that retains the relationship among the ports of the I/O switch 112, the information (type and device identifier) on an I/O device, and the server 111; and the virtual identifier table 123 that retains the device identifier and the virtual device identifier is described above, but it may suffice to provide configuration management information that retains a relationship among the server 111 coupled to each port of the I/O switches 112, the information on the I/O device, and the virtual identifier.

This invention has been described above in detail by referring to the accompanying drawings, but this invention is not limited to such specific configurations, and includes various changes and equivalent configurations within the gist of the scope of the claims appended hereto.

As described above, this invention can be applied to a computer system including a PCI-Express switch, in which a plurality of computers share an I/O device.

What is claimed is:

1. A computer system, comprising:
a plurality of computers each comprising a processor, a memory, and an I/O interface;
one or a plurality of I/O switches to which the plurality of computers are coupled via the I/O interface;
a plurality of I/O devices that are coupled to the one or plurality of I/O switches; and
a management server comprising configuration management information for managing the plurality of I/O devices coupled to the plurality of computers via the one or plurality of I/O switches, for controlling allocation of the plurality of I/O devices to the plurality of computers, wherein:
the management server comprises a configuration management module that receives a changeover from a first computer to a second computer among the plurality of computers and allocates the I/O device allocated to the first computer to the second computer;
the configuration management module comprises:
an identifier detection module that acquires an identifier of the first computer among the plurality of computers and an identifier of the I/O device allocated to the first computer and stores the identifier of the first computer and the identifier of the I/O device in the configuration management information;
an I/O switch changeover module that transmits an instruction to change over the I/O device allocated to the first computer to the second computer to the one or plurality of I/O switches; and
a device identifier rewriting module that rewrites an identifier of a specific I/O device within the configuration management information to a virtual identifier that has been previously set;
the I/O switch changeover module transmits, after stopping the first computer, the instruction to change over the I/O device allocated to the first computer to the second computer to the one or plurality of I/O switches; and
the device identifier rewriting module rewrites, after activating the second computer, the identifier of the specific I/O device among the I/O devices that have been changed over to the second computer to the virtual identifier.

2. The computer system according to claim 1, wherein:
the configuration management information retains a coupling relationship between the plurality of computers and the plurality of I/O devices that are coupled to the one or plurality of I/O switches, the identifiers serving as information on the plurality of I/O devices, and information indicating the specific I/O device; and
the identifier detection module is configured to:
acquire the identifier of the I/O device allocated to the first computer; and
set, when the I/O device is the specific I/O device, the information indicating the specific I/O device in the configuration management information.

3. The computer system according to claim 1, wherein:
the configuration management module further comprises a fault detection module that monitors the first computer and detects an occurrence of a fault; and
the configuration management module stops, when the fault detection module detects the occurrence of the fault of the first computer, the first computer and takes over the I/O device to the second computer.

4. The computer system according to claim 1, further comprising a third computer that is coupled to each of the plurality of computers, for managing operating states of the respective plurality of computers,
wherein the device identifier rewriting module transmits an instruction to rewrite the identifier of the specific I/O device among the I/O devices that have been changed over to the second computer to the virtual identifier to the third computer.

5. The computer system according to claim 1, further comprising:
a first network that is coupled to a fourth computer, for managing the plurality of computers; and
a second network that is coupled to the plurality of computers providing services, wherein:
the plurality of I/O devices comprise a first I/O device coupled to the first network and a second I/O device coupled to the second network; and
the device identifier rewriting module is configured to:
determine the first I/O device coupled to the first network among the plurality of I/O devices as the specific I/O device; and
rewrite an identifier of the first I/O device to the virtual identifier.

6. The computer system according to claim 1, wherein the device identifier rewriting module previously sets the virtual identifiers corresponding to identifiers of the plurality of I/O devices.

7. A control method for a computer system,
the computer system comprising:
a plurality of computers each comprising a processor, a memory, and an I/O interface; and
a management server that couples one or a plurality of I/O switches to which the plurality of computers are coupled via the I/O interface to a plurality of I/O devices and comprises configuration management information for managing the plurality of I/O devices coupled to the plurality of computers via the one or plurality of I/O switches,
the management server controlling allocation of the plurality of I/O devices to the plurality of computers,
the control method comprising:
a storing step of acquiring, by the management server, an identifier of a first computer among the plurality of computers and an identifier of the I/O device allocated to the first computer and storing the identifier of the first computer and the identifier of the I/O device in the configuration management information;
a reception step of receiving, by the management server, a changeover from the first computer to a second computer among the plurality of computers;
a stopping step of stopping, by the management server, the first computer;
a transmission step of transmitting, by the management server, an instruction to allocate the I/O device allocated to the first computer to the second computer to the one or plurality of I/O switches;
an activation step of activating, by the management server, the second computer; and
a rewriting step of rewriting, by the management server, an identifier of a specific I/O device among the I/O devices that have been changed over to the second computer to a virtual identifier that has been previously set.

8. The control method for a computer system according to claim 7, wherein:
the configuration management information retains a coupling relationship between the plurality of computers and the plurality of I/O devices that are coupled to the one or plurality of I/O switches, the identifiers serving as information on the plurality of I/O devices, and information indicating the specific I/O device; and
the storing step comprises:
acquiring, by the management server, the identifier of the I/O device allocated to the first computer; and
setting, by the management server, when the I/O device is the specific I/O device, the information indicating the specific I/O device in the configuration management information.

9. The control method for a computer system according to claim 7, wherein the reception step comprises monitoring, by the management server, the first computer and when detecting an occurrence of a fault, receiving the changeover from the first computer to the second computer.

10. The control method for a computer system according to claim 7, wherein:
the computer system further comprises a third computer that is coupled to each of the plurality of computers, for managing operating states of the respective plurality of computers; and
the rewriting step comprises transmitting, by the management server, an instruction to rewrite the identifier of the specific I/O device among the I/O devices that have been changed over to the second computer to the virtual identifier to the third computer.

11. The control method for a computer system according to claim 7, wherein:
the computer system further comprises:
a first network that is coupled to a fourth computer, for managing the plurality of computers; and
a second network that is coupled to the plurality of computers providing services;
the plurality of I/O devices comprise a first I/O device coupled to the first network and a second I/O device coupled to the second and network; and
the rewriting step comprises determining, by the management server, the first I/O device coupled to the first network among the plurality of I/O devices as the specific I/O device, and rewriting an identifier of the first I/O device to the virtual identifier.

12. The control method for a computer system according to claim 7, wherein the rewriting step comprises previously setting, by the management computer, the virtual identifiers corresponding to identifiers of the plurality of I/O devices.

13. A storage medium having a program, which is used in a computer system, stored thereon,
the computer system comprising:
a plurality of computers each comprising a processor, a memory, and an I/O interface; and
a management server that couples one or a plurality of I/O switches to which the plurality of computers are coupled via the I/O interface to a plurality of I/O devices and comprises configuration management information for managing the plurality of I/O devices coupled to the plurality of computers via the one or plurality of I/O switches,
the program being used by the management server to control allocation of the plurality of I/O devices to the plurality of computers,
the program controlling the management server to execute the procedures of:
acquiring an identifier of the I/O device allocated to a first computer among the plurality of computers and storing the identifier in the configuration management information;
receiving a changeover from the first computer to a second computer among the plurality of computers;
stopping the first computer;
transmitting an instruction to allocate the I/O device allocated to the first computer to the second computer to the one or plurality of I/O switches;
activating the second computer; and
rewriting an identifier of a specific I/O device among the I/O devices that have been changed over to the second computer to a virtual identifier that has been previously set.
